(19) United States
(12) Patent Application Publication
(10) Pub. No.: US 2008/0150440 A1
(43) Pub. Date: Jun. 26, 2008

(54) LED light string with guaranteed conduction

(75) Inventor: Sheng-Hung Hsu, Renwu Hsiang (TW)

Correspondence Address: COOPER & DUNHAM, LLP, 1185 AVENUE OF THE AMERICAS, NEW YORK, NY, 10036, US

(73) Assignee: Gemmy Industries Corporation

(21) Appl. No.: 11/708,300

(22) Filed: Feb. 20, 2007

(30) Foreign Application Priority Data
Dec. 22, 2006 (CN) 200610167685.4

(51) Int. Cl. H05B 37/00

(52) U.S. Cl. 315/191

(57) ABSTRACT

An LED light string with guaranteed conduction has a plurality of LEDs connected in series to form a light string. Both ends of the light string are connected with a power supply to form a closed circuit. Each LED on the light string is connected with a bypass element in parallel. The bypass element can be a Zener diode with a forward voltage higher than that of the LED. When any LED on the light string fails, the current still flows through the circuit via the corresponding bypass element. Therefore, the light string is guaranteed to be conductive even when some of the LED's are broken.

### BACKGROUND OF THE INVENTION

1. Field of the Invention

The invention relates to an LED light string and, in particular, to an LED light string that can function normally even when some of its LED's fail.

2. Description of Related Art

As the light-emitting diode (LED) has the advantages of low power consumption and long lifetime, LED's of different colors have been developed and used in various situations, speeding up the illumination application thereof. Although the LED meets the basic requirements of illumination and has some advantages, a single LED cannot provide sufficient illumination in practice. In this case, a large number of LED's have to be used. As in the case of connecting light bulbs, the voltage that should be imposed on the LED's connected in series has to be large. If the forward voltage for a single LED is 1.8V, then connecting five LED's in series requires a forward voltage of 9V. This can be driven by a single 9V power supply. However, the serial connection has a serious potential problem. That is, all of the LED's are connected in series on the same loop. If any of them is out of order, the circuit is broken. The entire light string cannot function even if the other LED's are all right.

### SUMMARY OF THE INVENTION

It is therefore imperative to provide a solution for the problem that any broken LED will result in the malfunction of the entire light string when the LED's are connected in series.

In view of the foregoing, an objective of the invention is to provide an LED light string with guaranteed conduction, so that even if some of the LED's are out of order the other LED's can still illuminate normally. Therefore, the invention can effectively solve the problem in the prior art.

To achieve the above objective, the disclosed LED light string includes:

a light string, which includes a plurality of LED's connected in series and has both ends connected to a power supply to form a closed circuit;

a plurality of bypass elements for the LED's, each of which is connected across both ends of the corresponding LED and is a Zener diode with a forward voltage larger than the forward voltage of the associated LED.

In accord with the invention, each LED in the circuit is connected in parallel with a bypass element. When all of the LED's in the circuit are functioning normally, the current prefers to flow through them and light them up because the forward voltage of each LED is lower than the associated bypass element. If any of the LED is broken, the current does not flow through it and flows through its associated bypass element instead. This maintains a conductive circuit so that the light string can function as well.

The above-mentioned LED's can have different colors and different forward voltages.

### BRIEF DESCRIPTION OF THE DRAWINGS

FIG. 1 is a circuit diagram of the invention.

### DETAILED DESCRIPTION OF THE PREFERRED EMBODIMENT

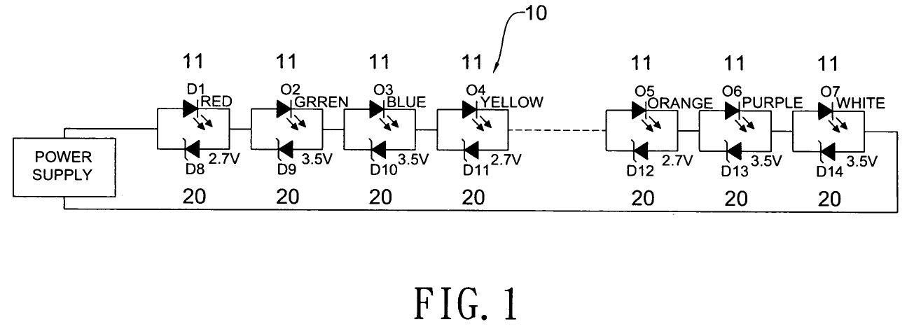

As shown in the circuit diagram in FIG. 1, a preferred embodiment of the invention comprises a light string 10 and multiple bypass elements 20.

The light string 10 comprises several LED's 11 connected in series. Both ends of the light string 10 are connected with a power supply to form a closed circuit. The LED's may have the same color and same forward voltage or different colors. When they have different colors, they can have different forward voltages. In this embodiment, the LED's 11 on the light string 10 have different colors.

Each of the bypass elements 20 is connected to both ends of the corresponding LED 11 in a one-to-one correspondence way. In this embodiment, the bypass element 20 is a Zener diode. The Zener diodes may have different breakdown voltages. How to select the appropriate breakdown voltages depends on the forward voltage of the associated LED 11 connected in parallel. More explicitly, for the light string 10 to function normally under usual conditions, the forward voltage of each bypass element 20 has to be greater than the forward voltage of the associated LED 11 connected in parallel. As described above, the light string 10 in this embodiment consists of LED's 11 of different colors connected in series. Therefore, the forward voltages of the LED's 11 are not all the same. The breakdown voltage of the Zener diode is chosen correspondingly to be larger than the associated LED 11 connected in parallel.

The detailed structure of a preferred embodiment of the invention has been described above. In the following, we describe in detail its function principle.

When each LED 11 in the serial circuit of the light string 10 functions normally, the forward voltage of the LED 11 is smaller than its associated bypass element 20. Therefore, the current flows primarily through the LED's 11 because they have smaller resistance. All of the LED's 11 on the circuit are thus conductive and lit up. If any of the LED's 11 is broken, its forward voltage is greater than the breakdown voltage of its associated bypass element 20. In this case, the bypass element 20 is conductive. Therefore, the circuit is not broken, and the light string 10 can still function normally.

According to the invention, each LED in the serial light string is connected in parallel with a bypass element. When the LED's function normally, the current flows through all of them. Once an LED is broken, its associated bypass element provides a bypass route for the current, so that the circuit is not broken due to the damage on a local LED. This ensures that the light string can function even when some of the LED's are broken. Moreover, Zener diodes are used as the bypass elements. Therefore, the voltage on the circuit is stabilized. Even if some LED's on the circuit are broken, the voltage still has high stability.

What is claimed is:

1. A light-emitting diode (LED) light string with guaranteed conduction comprising:
a light string composed of multiple light emitting diodes (LEDs) connected in series and having two ends for connecting to a power supply;
multiple bypass elements, each of which is connected in parallel to a corresponding LED in a one-to-one correspondence way.

2. The LED light string as claimed in claim 1, wherein each bypass element is a Zener diode with a forward voltage greater than a forward voltage of the associated LED connected in parallel.

3. The LED light string as claimed in claim 1, wherein the multiple LED's have different colors and different forward voltages.
